(19) United States
(12) Patent Application Publication
(10) Pub. No.: US 2015/0050538 A1
(43) Pub. Date: Feb. 19, 2015

(54) ENERGY STORAGE APPARATUS

(71) Applicant: SAMSUNG SDI CO., LTD., Yongin-si (KR)

(72) Inventor: Hyojoon CHOI, Yongin-si (KR)

(73) Assignee: SAMSUNG SDI CO., LTD., Yongin-si (KR)

(21) Appl. No.: 14/220,187

(22) Filed: Mar. 20, 2014

(30) Foreign Application Priority Data
Aug. 14, 2013 (KR) 10-2013-0096849

(51) Int. Cl. H01M 2/10

(52) U.S. Cl. CPC H01M 2/1016
USPC 429/121

(57) ABSTRACT

An energy storage apparatus includes a plurality of battery cells, each battery cell including a current collecting terminal, and at least one tray receiving the plurality of battery cells, the tray including a coupling portion protruding in a first direction from a first surface of the tray, the coupling portion including an electrode unit having a first end electrically connected to the current collecting terminal and a second end movable in the first direction.

### CROSS-REFERENCE TO RELATED APPLICATION

Korean Patent Application No. 10-2013-0096849, filed on Aug. 14, 2013, in the Korean Intellectual Property Office, and entitled: “Energy Storage Apparatus,” is incorporated by reference herein in its entirety.

### BACKGROUND

1. Field

Embodiments relate to an energy storage apparatus.

2. Description of the Related Art

An energy storage apparatus is configured to be linked with a novel renewal energy and power system, e.g., a solar cell, to store electric power when there is low demand for the electric power from a load, and to use the stored electric power when there is high demand for the electric power. The energy storage apparatus may include a large quantity of secondary batteries used in, for example, electric devices, e.g., mobile phones, notebook computers, and so on. The large quantity of secondary batteries are received in a plurality of trays, which are connected through a plurality of cable harnesses, including a power cable, a communication cable, voltage and temperature sensing cables, and so on, to then be stacked one on another.

### SUMMARY

Embodiments provide an energy storage apparatus including a plurality of battery cells, each battery cell including a current collecting terminal, and at least one tray receiving the plurality of battery cells, the tray including a coupling portion protruding in a first direction from a first surface of the tray, the coupling portion including an electrode unit having a first end electrically connected to the current collecting terminal and a second end movable in the first direction.

Current collecting terminals of neighboring battery cells among the plurality of battery cells may be electrically connected to each other through a bus bar, and one of the current collecting terminals of the plurality of battery cells is electrically connected to one end of the electrode unit.

The electrode unit may include a body part passing through the first surface, and a connecting portion extending from the body part in a second direction opposite to the first direction.

The connecting portion may include a receiving groove shaped to fit the current collecting terminal.

A through-hole may be formed on the first surface to allow the body part to pass therethrough.

The coupling portion may include a support unit formed on the first surface to surround exterior parts of the body part.

When the electrode unit moves in the first direction, a bottom surface of the receiving groove and a top surface of the current collecting terminal may be made to be spaced apart from each other, and when the electrode unit moves in the second direction, the bottom surface of the receiving groove and the top surface of the current collecting terminal may be brought into contact with each other.

An inner wall of the receiving groove and an outer wall of the current collecting terminal may be brought into contact with each other.

The electrode unit may further include an elastic body having one end coupled to the bottom surface of the connecting portion and the other end coupled to the top surface of the current collecting terminal.

The electrode unit may further include an elastic body having one end coupled to the bottom surface of the connecting portion and the other end coupled to the top surface of the current collecting terminal.

The coupling portion may further include a connector unit formed on the first surface to be integrally formed with a battery management system (BMS) board electrically connected to the plurality of battery cells.

The coupling portion may further include a first fixing unit spaced apart from the connector unit and protruding in the first direction.

The tray may have a coupling groove formed on its second surface opposite to the first surface, the coupling groove shaped to fit the coupling portion.

The coupling groove may include a stepped portion shaped to fit the electrode unit.

The tray may include a plurality of side surfaces between the first surface and the second surface to connect the first surface to the second surface, and at least one second fixing unit and a first guide groove may be formed on a first side surface adjacent to the electrode unit among the side surfaces, the at least one second fixing unit protruding in a third direction that is perpendicular to the first or second direction and exterior to the tray, and the first guide groove guiding movement of the electrode unit.

The first guide groove may include a guide unit formed in a direction in which the electrode unit moves and a locking unit extending from both ends of the guide unit in a direction perpendicular to the direction in which the electrode unit moves.

The electrode unit may further include a guide bar extending in the third direction to be fitted into the first guide groove.

The guide bar may include a moving unit extending from the electrode unit in the third direction and moving in a state in which it is fit into the first guide groove, and a handle unit formed at an end of the moving unit to be thicker than the moving unit and locked on the locking unit.

A second guide groove may be formed on the first side surface to be symmetrical to the first guide groove in view of a central region of the first side surface.

The electrode unit can be rotated inside the support unit by the guide bar.

The tray may be configured such that another tray having a coupling groove shaped to fit the coupling portion is stacked thereon in the first direction.

The tray may be configured such that another tray having a fixing groove shaped to fit the second fixing unit and a guide groove shaped to fit the first guide groove is stacked thereon in the third direction.

### BRIEF DESCRIPTION OF THE DRAWINGS

Features will become apparent to those of ordinary skill in the art by describing in detail exemplary embodiments with reference to the attached drawings, in which:

FIG. 1 illustrates a perspective view of an energy storage apparatus according to an embodiment;

FIG. 2 illustrates a perspective view of a tray of the energy storage apparatus shown in FIG. 1:

FIG. 3 illustrates a perspective view of battery cells received in the tray shown in FIG. 2;

FIG. 4A illustrates a plan view of a top surface of the tray shown in FIG. 2;

FIG. 4B illustrates a plan view of a bottom surface of the tray shown in FIG. 2;

FIG. 4C illustrates a side view of a right side surface of the tray shown in FIG. 2;

FIG. 4D illustrates a side view of a left side surface of the tray shown in FIG. 2;

FIG. 5 illustrates a sectional view along lines I-I of the tray shown in FIG. 1;

FIGS. 6A and 6B illustrate enlarged sectional views of an operation of region ‘A’ of FIG. 5;

FIGS. 7A and 7B illustrate enlarged sectional views of another embodiment of the operation of region ‘A’ of FIG. 5;

FIGS. 8A and 8B illustrate enlarged sectional views of still another embodiment of the operation of region ‘A’ of FIG. 5; and

FIGS. 9A and 9B illustrate enlarged sectional views of an operation of region corresponding to the operation of the ‘A’ region of FIG. 5.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

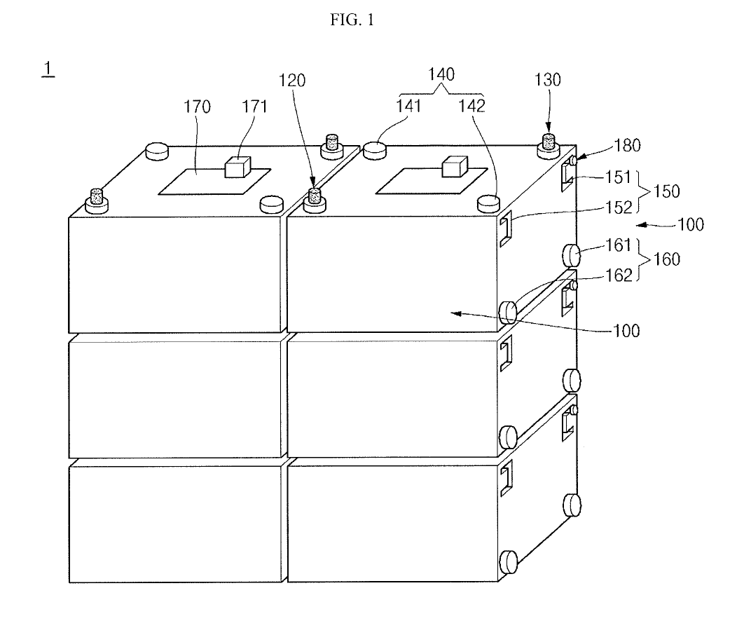

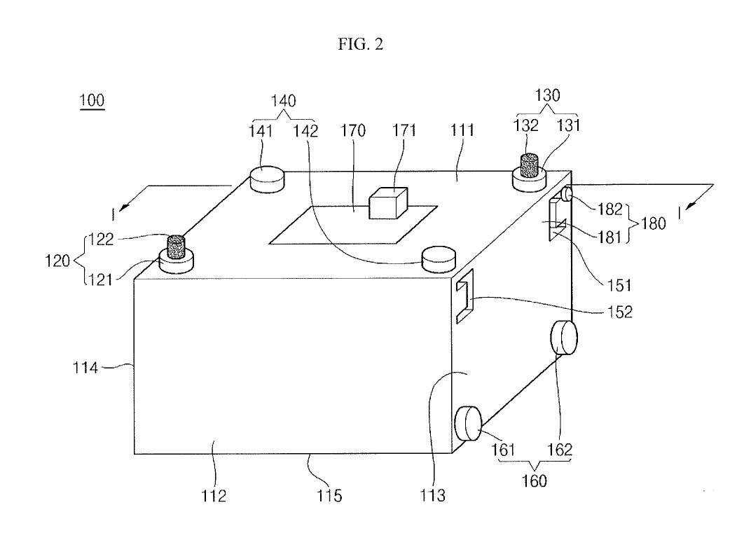

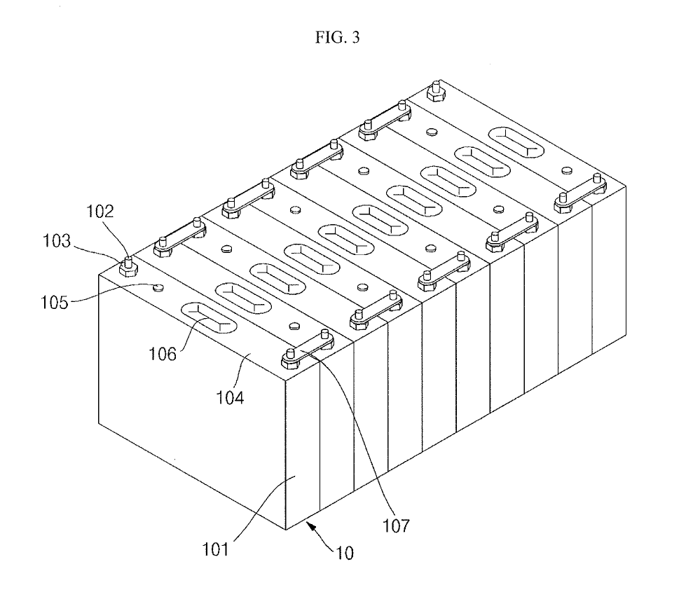

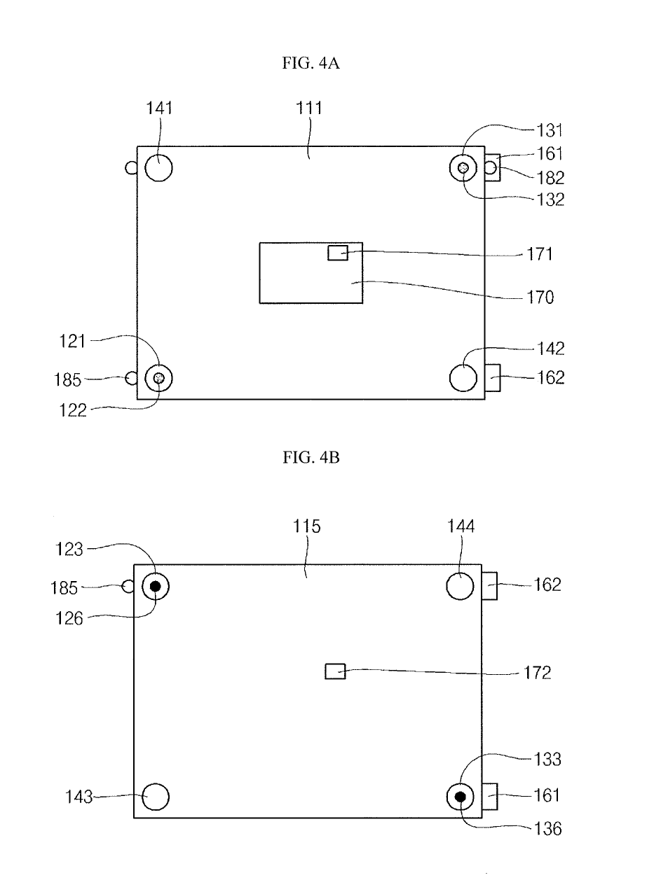

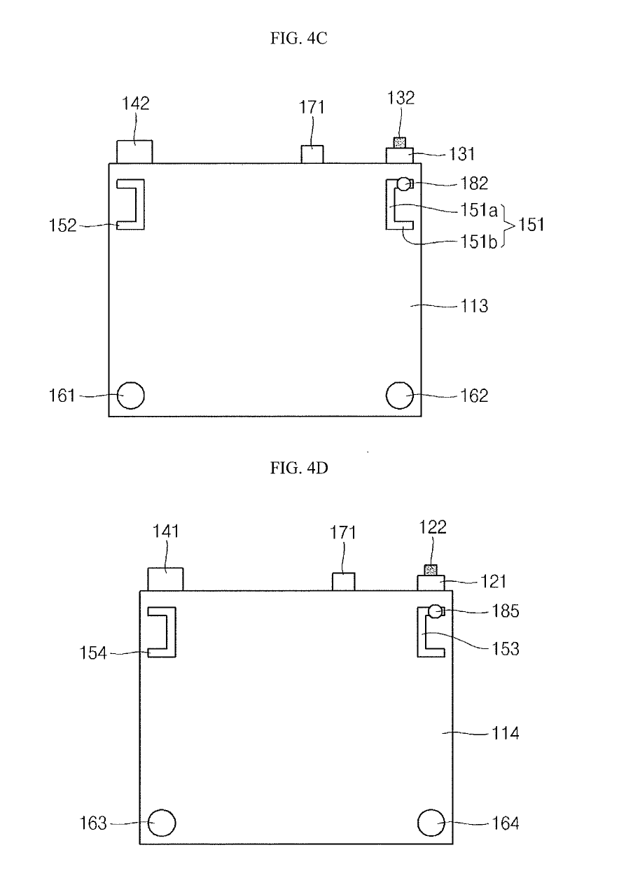

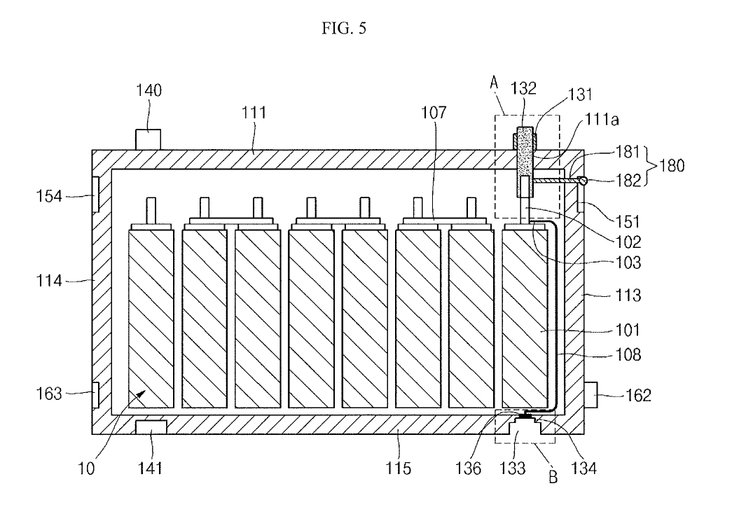

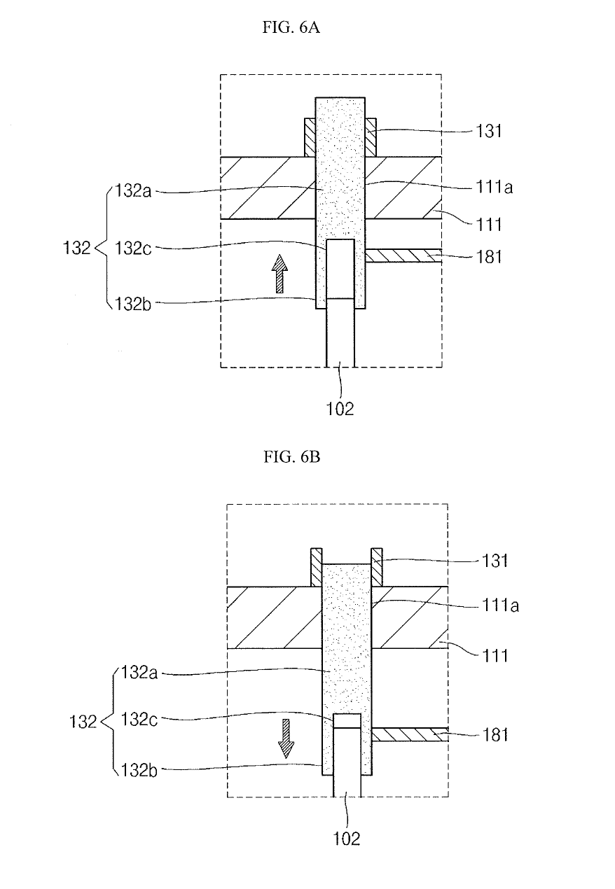

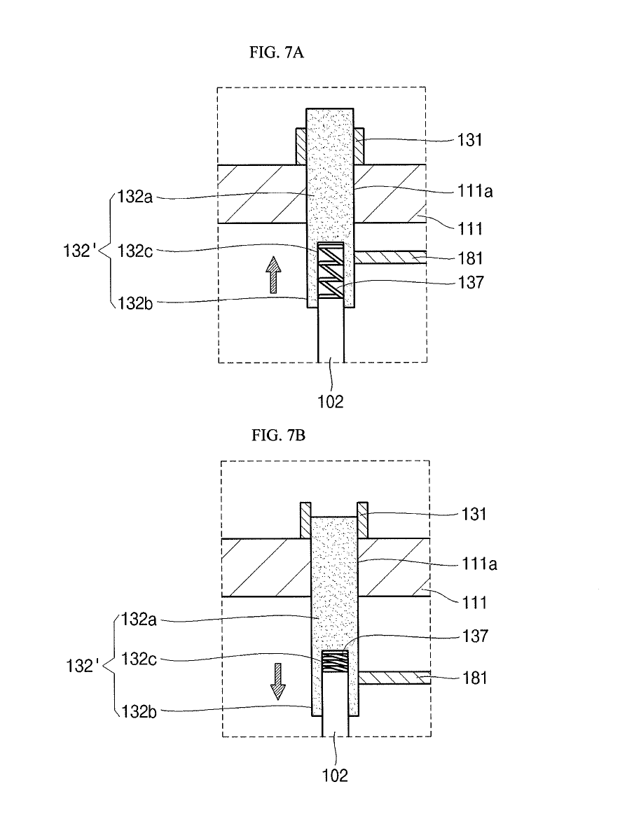

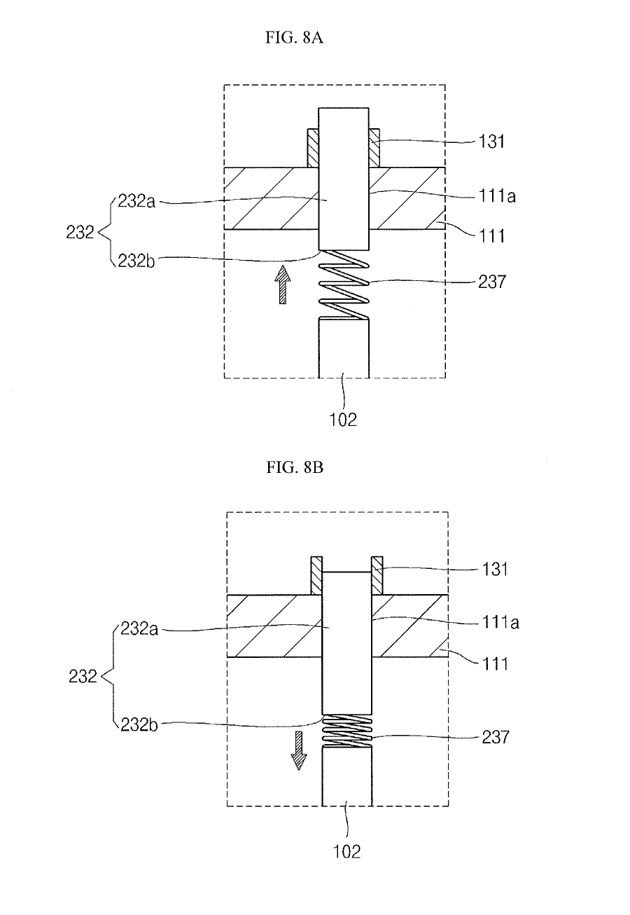

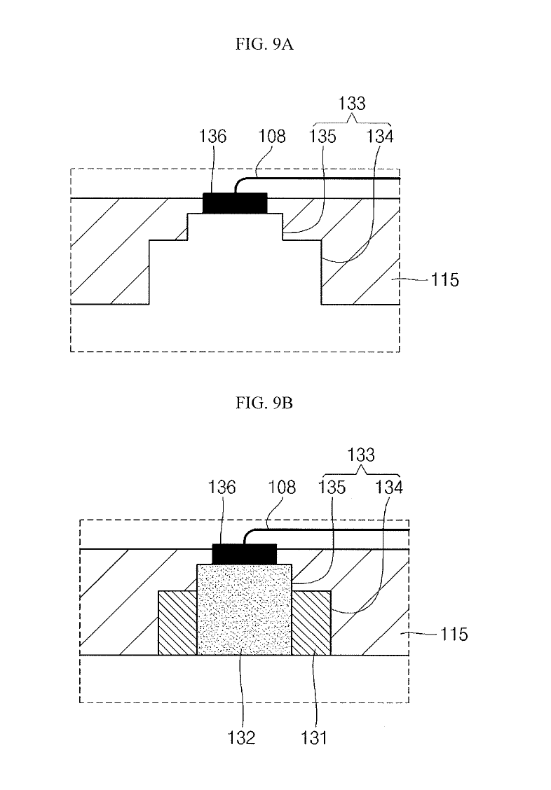

FIG. 1 illustrates a perspective view of an energy storage apparatus according to an embodiment, FIG. 2 illustrates a perspective view of a tray of the energy storage apparatus shown in FIG. 1, FIG. 3 illustrates a perspective view of battery cells received in the tray shown in FIG. 2, FIG. 4A illustrates a plan view of a top surface of the tray shown in FIG. 2, FIG. 4B illustrates a plan view of a bottom surface of the tray shown in FIG. 2, FIG. 4C illustrates a side view of a right side surface of the tray shown in FIG. 2, FIG. 4D illustrates a side view of a left side surface of the tray shown in FIG. 2, FIG. 5 illustrates a sectional view of the tray shown in FIG. 1, taken along the line I-I, FIGS. 6A and 6B illustrate enlarged sectional views of an operation of an ‘A’ region of FIG. 5, FIGS. 7A and 7B illustrate enlarged sectional views of another embodiment of the operation of the ‘A’ region of FIG. 5, FIGS. 8A and 8B illustrate enlarged sectional views of still another embodiment of the operation of the ‘A’ region of FIG. 5, and FIGS. 9A and 9B illustrate enlarged sectional views of an operation of a ‘B’ region, corresponding to the operation of the ‘A’ region of FIG. 5.

Referring to FIGS. 1 to 3 and FIG. 5, an energy storage apparatus according to an embodiment is configured to include a plurality of trays 100 stacked in vertical and/or horizontal directions. The trays 100 may be configured to receive a plurality of battery cells 10 arranged in parallel in the horizontal direction.

The plurality of battery cells 10 may be stacked in each tray 100 in the horizontal direction. As shown in FIG. 3, general prismatic battery cells may be used as the battery cells 10, but embodiments are not limited thereto. For example, various kinds of battery cells, e.g., cylindrical battery cells or pouch-type battery cells, may also be used as the battery cells 10.

The battery cells 10 may be general secondary batteries. Each of the battery cells 10 may include an electrode assembly (not shown) and an electrolytic solution (not shown). The electrode assembly may include a positive electrode plate, a negative electrode plate, and a separator. The electrolytic solution may include a lithium ion. The positive and negative electrode plates of the electrode assembly may be electrically connected to current collectors (not shown) to be drawn to the outside.

Referring to FIG. 3, the electrode assembly of the battery cell 10 may be received inside a case 101, and a current collecting terminal 102 fixed by a nut 103 may be exposed to the outside of the case 101. The current collectors (not shown) electrically connected to the positive and negative electrode plates may be electrically connected to the current collecting terminal 102 inside the case 101. For example, the case 101 may be cylindrical or prismatic. In the battery cells 10, a plurality of electrode assemblies may be included within a single case 101.

In the plurality of battery cells 10, the respective battery cells 10 may be stacked in the horizontal direction. The current collecting terminal 102 of neighboring battery cells 10 stacked to be adjacent to each other among the plurality of battery cells 10 may be electrically connected to each other. Here, the current collecting terminals 102 of the neighboring battery cells 10 may be electrically connected to each other by a bus bar 107.

The neighboring battery cells 10 may be arranged such that positive and negative electrodes are alternately disposed. The plurality of battery cells 10 may be connected to each other in parallel, in series, or in a combination of series and parallel connections. Accordingly, the plurality of battery cells 10 may be continuously connected to each other to form a single battery module. For example, as illustrated in FIG. 3, ten battery cells 10 may be received in a single tray 100. However, the connection structure and number of battery cells 10 may be determined in consideration of the charge or discharge capacity required at the time of designing.

A cap plate 104 may be coupled to an opening of the case 101. The cap plate 104 may be formed of a thin plate. An electrolytic solution injection hole 105, through which an electrolytic solution is injected, may be formed in the cap plate 104. The electrolytic solution injection hole 105 may be sealed by a plug after the electrolytic solution is injected. In addition, a vent member 106 having a groove may be formed in the cap plate 104 so as to be ruptured according to a preset internal pressure.

As described above, the battery cells 10 according to the embodiments may be lithium-ion secondary batteries, but embodiments are not limited thereto. In addition to the lithium-ion secondary batteries, various kinds of batteries, e.g., nickel-cadmium secondary batteries, nickel-hydrogen secondary batteries, lithium secondary batteries, and so on may be used as the battery cells 10 according to the embodiments.

Referring to FIG. 2, each of the trays 100 may include at least a first surface 111, a second surface 115, a third surface 113, a fourth surface 114, and a fifth surface 112, so the plurality of battery cells 10 may be received in a space formed, e.g., defined, at least by the first surface 111, e.g., a first sidewall, the second surface 115, the third surface 113, the fourth surface 114, and the fifth surface 112. In the energy storage apparatus according to embodiments, one or more trays 100 are stacked in vertical and/or horizontal directions. To this end, one or more coupling units are formed on the first surface 111, the second surface 115, the third surface 113, and the fourth surface 114 of each of the trays 100.

Referring to FIGS. 2 and 4A, the first surface 111 corresponds to a top surface of the tray 100 and includes coupling portions 120 and 130, a connector unit 171, and a first fixing unit 140 formed thereon.

The coupling portions 120 and 130 protrude in a first direction, i.e., in an upward direction, with respect to the first surface 111. The coupling portions 120 and 130 may be coupled to the trays 100 stacked in the first direction to be adjacent to the first surface 111, and may fix respective trays 100 to electrically connect first electrodes of the trays 100. The coupling portions 120 and 130 may be cylindrical, but embodiments are not limited thereto.

The coupling portions 120 and 130 include a first electrode unit 132 and a second electrode unit 122. The first and second electrode units 132 and 122 are movable through the first surface 111 along a direction normal to the first surface 111, as will be discussed in more detail below with reference to FIGS. 6A-6B.

The first electrode unit 132 has a first end electrically connected to a current collecting terminal of each of the battery cells 10 and a second end movable in the first direction to be exposed to the outside of the tray 100. That is, the first end of the first electrode unit 132 is inside an interior of a space defined by the first through fourth surfaces 111 through 115, and is electrically connected to one of current collecting terminals of the battery cells 10. The first end of the first electrode unit 132 is electrically connected to either a positive electrode current collecting terminal or a negative electrode current collecting terminal of each of the plurality of battery cells 10. The second end of the first electrode unit 132 moves up and down along a perpendicular direction to the first surface 111, and is exposed to an exterior of the space defined by the first through fourth surfaces 111 through 115. That is, the first electrode unit 132 moves up and down within, e.g., through, a support unit 131, so the second end of the first electrode unit 132 moves up and down outside of the support unit 131. The first electrode unit 132 may be cylindrical, but embodiments are not limited thereto.

In detail, as illustrated in FIG. 6A, the first electrode unit 132 may include a body part 132a and a connecting portion 132b. The body part 132a is formed to pass through a through-hole 111a formed through a sidewall corresponding to the first surface 111, i.e., a top of the body part 132a is the first end of the first electrode unit 132. The connecting portion 132b extends from the body part 132a in a second direction opposite to the first direction. That is to say, the connecting portion 132b extends from the body part 132a to the inside of the tray 100, e.g., the connecting portion 132b may extend into the interior of the space defined by the first through fourth surfaces 111 through 115.

A receiving groove 132c is formed at a lower region of the connecting portion 132b. The receiving groove 132c is shaped to fit an end of the current collecting terminal 102, e.g., the current collecting terminal 102 may have a complementary shape to the receiving groove 132c to be inserted into the groove 132c.

Therefore, as shown in FIG. 6A, when the first electrode unit 132 moves in the first direction, i.e., upward relatively to the first surface 111, a bottom surface 132d of the receiving groove 132c and a top surface of the current collecting terminal 102 are spaced apart from each other. As shown in FIG. 6B, when the first electrode unit 132 moves in the second direction, i.e., downward relatively to the first surface 111, the bottom surface 132d of the receiving groove 132c and the top surface of the current collecting terminal 102 are brought into contact with each other or have a reduced space therebetween, i.e., a space smaller than a space formed when the first electrode unit 132 moves in the first direction. When the first electrode unit 132 moves up or down, an inner wall of the receiving groove 132c and an outer wall of the current collecting terminal 102 are maintained at a contact state, so that they are electrically connected to each other all the time.

According to another embodiment, referring to FIGS. 7A and 7B, a first electrode unit 132′ may further include an elastic body 137 having a first end coupled to a bottom surface of the receiving groove 132c and a second end coupled to a top surface of the current collecting terminal 102. Therefore, when the first electrode unit 132′ moves in the first and second directions, the first electrode unit 132 is more easily moved by a restoring force of the elastic body 137. Further, when the first electrode unit 132′ moves in the first and second directions, the bottom surface of the receiving groove 132c and the top surface of the current collecting terminal 102 may not be brought into direct contact with each other, i.e., the elastic body may separate therebetween. Accordingly, it is possible to prevent the bottom surface of the receiving groove 132c and the top surface of the current collecting terminal 102 from being damaged due to a, e.g., direct, contact therebetween. The elastic body 137 may be a spring, but embodiments are not limited thereto.

According to still another embodiment, referring to FIGS. 8A and 8B, a first electrode unit 232 may include a body part 232a shaped as a rod with a planar bottom surface 232b, i.e., a connecting portion 232b without a groove. In addition, the first electrode unit 232 may further include an elastic body 237 having a first end coupled to a bottom surface of the connecting portion 232b and a second end coupled to a top surface of the current collecting terminal 102. Therefore, when the first electrode unit 232 moves in the first and second directions, the first electrode unit 232 is more easily moved by a restoring force of the elastic body 237. Further, when the first electrode unit 232 moves in the first and second directions, the bottom surface of the connecting portion 232b and the top surface of the current collecting terminal 102 may not be brought into direct contact with each other. Accordingly, it is possible to prevent the bottom surface of the connecting portion 232b and the top surface of the current collecting terminal 102 from being damaged due to a contact therebetween.

As illustrated in FIGS. 6A-8B, the first electrode units 132, 132′, 232 may further include a support unit 131 formed on the first surface 111 to surround exterior parts of respective body parts 132a and 232a. The support unit 131 provides a space therein to allow respective body parts 132a and 232a to move up and down. In addition, the support unit 131 may serve to support the respective body parts 132a and 232a on the first surface 111 while preventing the exterior parts of respective body parts 132a and 232a from being exposed to the outside. The support unit 131 may be shaped to surround the exterior parts of respective body parts 132a and 232a, but may have various shapes varying according to the shape of the respective body parts 132a and 232a. The support unit 131 may be made of a non-metal material that is not conductive.

Referring back to FIG. 2, the second electrode unit 122 is formed to be movable in the first direction such that a first end thereof is electrically connected to the current collecting terminal 102 of each of the battery cells 10 and a second end thereof is exposed to the outside of the tray 10. The first end of the second electrode unit 122 is electrically connected to one of a positive electrode current collecting terminal and a negative electrode current collecting terminal of each of the plurality of battery cells 10. That is to say, the first end of the second electrode unit 122 is connected to the current collecting terminal having a polarity opposite to that of the first end of the first electrode unit 132. The second end of the second electrode unit 122 moves up and down to be perpendicular to the first surface 111 to be exposed from the inside of a support unit 121 to the outside of the support unit 121. The configuration and shape of the second electrode unit 122 are substantially the same as those of the first electrode unit 132, and detailed descriptions thereof will be omitted.

A further illustrated in FIG. 2, the connector unit 171 protrudes from the first surface 111 in the first direction to be spaced apart from the coupling portions 120 and 130 and the first fixing unit 140. The connector unit 171 is coupled to the trays 100 stacked in the first direction to be adjacent to the first surface 111 to perform communications of the trays 100 while fixing the trays 100 by coupling the trays 100 to each other. In addition, the connector unit 171 is formed on the first surface 111 to be integrally formed with a battery management system (BMS) board 170 including a protective circuit device (not shown) electrically connected to the plurality of battery cells 10 and controlling charging and discharging of the battery cells 10 and protecting the battery cells 10. That is to say, the connector unit 171 has a bottom end electrically connected to the BMS board 170.

When the tray 100 is configured such that another tray 100 is stacked thereon in the first direction, the connector unit 171 may couple the respective trays 100 to each other and may fix the same to perform communications of the trays 100. The connector unit 171 may be prismatic, but embodiments are not limited the shape of the connector unit 171 to that stated herein.

The first fixing unit 140 protrudes from the first surface 111 in the first direction to be spaced apart from the coupling portions 120 and 130 and the connector unit 171. The first fixing unit 140 is coupled to the trays 100 stacked in the first direction to be adjacent to the first surface 111 and fixes the trays 100. The first fixing unit 140 may include one or more fixing units 141 and 142 and may be cylindrical, but embodiments are not limited to the shape and number of the first fixing unit 140 stated herein. The first fixing unit 140 may be made of a non-metal material that is not conductive.

Referring to FIG. 4B, the second surface 115 corresponds to a bottom surface of each of the trays 100 and includes coupling grooves 123 and 133, a connector groove 172, and first fixing grooves 143 and 144 formed thereon.

The coupling grooves 123 and 133 are sized and shaped to fit the coupling portions 120 and 130 formed on the first surface 111 of the tray 100. That is to say, the coupling grooves 123 and 133 are sized and shaped to fit the coupling portions 120 and 130 formed on the trays 100 stacked in a second direction (that is, in a downward direction) to be adjacent to the second surface 115 so as to be engaged with the coupling portions 120 and 130. Since the coupling grooves 123 and 133 have the same configuration, the following description will be made with regard to the coupling groove 133.

In more detail, referring to FIGS. 9A and 9B, the coupling groove 133 includes a first stepped portion 134, a second stepped portion 135, and a connection terminal portion 136. When two trays 100 are stacked in the second direction, i.e., on top of each other, the coupling portion 130 on top of a bottom tray 100 is inserted into the coupling groove 133 in a bottom of the top tray 100. That is, the first electrode unit 132 with the support unit 131 of the coupling portion 130 are accommodated in the second and first stepped portions 134 and 135.

In detail, the first stepped portion 134 is formed to have a depth corresponding to that of the support unit 131 of the coupling portion 130 formed on the first surface 111 of the tray 100. Therefore, the first stepped portion 134 is coupled to the support unit 131 in close contact with the support unit 131 formed on the trays 100 stacked in the second direction to be adjacent to the second surface 115. The second stepped portion 135 is formed to have a depth corresponding to that of the first electrode unit 132, i.e., when extended upward to the maximum, of the coupling portion 130 formed on the first surface 111 of the tray 100. Therefore, when the first electrode unit 132, formed on each of the trays 100 stacked in the second direction to be adjacent to the second surface 115, moves upwardly to the maximum, a bottom surface of the second stepped portion 135 and a top surface of the first electrode unit 132 are brought into close contact with each other. The connection terminal portion 136 is formed on the bottom surface of the second stepped portion 135 to be electrically connected to the first electrode unit 132 of each of the trays 100 stacked in the second direction to be adjacent to the second surface 115 through a conductive wire 108.

The connector groove 172 is sized and shaped to fit the connector unit 171 formed on the first surface 111 of each of the trays 100. That is to say, the connector groove 172 is sized and shaped to fit the connector unit 171 so as to be engaged with the connector unit 171 formed on each of the trays 100 stacked in the second direction to be adjacent to the second surface 115. Therefore, the connector groove 172 is engaged with the connector unit 171 formed on each of the trays 100 stacked in the second direction to be adjacent to the second surface 115 and performs communications of the trays 100 while fixing the trays 100 by coupling the trays 100 to each other.

The first fixing grooves 143 and 144 are sized and shaped to fit the first fixing unit 140 formed on the first surface 111 of each of the trays 100. That is to say, the first fixing grooves 143 and 144 are sized and shaped to fit the first fixing unit 140 so as to be engaged with the first fixing unit 140 formed on each of the trays 100 stacked in the second direction to be adjacent to the second surface 115. Therefore, the first fixing grooves 143 and 144 are formed on a bottom surface of the tray 100, i.e., on the second surface 115 of each of the trays 100, to be coupled to the first fixing unit 140 of each of the trays 100 stacked in the second direction to be adjacent to the second surface 115, thereby fixing the trays 100 to each other.

Referring to FIG. 4C, the third surface 113 corresponds to a right side surface of the tray 100 and includes second fixing units 161 and 162, a first guide groove 151, and a second guide groove 152 formed thereon.

The second fixing units 161 and 162 protrude on the third surface 113 in a direction (that is, in a right direction of the tray 100) perpendicular to the first and second directions. The second fixing units 161 and 162 are coupled to the trays 100 stacked in the third direction to be adjacent to the third surface 113 and fix the respective trays 100. The second fixing units 161 and 162 may be cylindrical, but embodiments are not limited to the shapes of the second fixing units 161 and 162 stated herein. The second fixing units 161 and 162 may be made of a non-metal material that is not conductive.

The first guide groove 151 is formed in a region of the third surface 113, which is adjacent to the first electrode unit 132 formed on the first surface 111. The first guide groove 151 is formed such that a guide bar 180 extending from the first electrode unit 132 in the third direction is fitted into the first guide groove 151. The first guide groove 151 guides movement of the first electrode unit 132 by the guide bar 180 moving along the corresponding groove.

In detail, the first guide groove 151 includes a guide unit 151a and a locking unit 151b. The guide unit 151a is formed in a direction in which the first electrode unit 132 moves and provides a path in which the first electrode unit 132 moves up and down, e.g., the guide unit 151 may be a groove within the third surface 113 that extends parallel to the first electrode unit 132. The locking unit 151b extends from both ends of the guide unit 151a in a direction perpendicular to the direction in which the first electrode unit 132 moves. In order to fix the first electrode unit 132 moving up and down, the locking unit 151b is formed to have a width greater than that of a handle unit 182 of the guide bar 180 extending from the first electrode unit 132 in the third direction. The first guide groove 151 may be formed to have a “U” shape, but embodiments do not limit the shape of the first guide groove 151 to that stated herein.

The guide bar 180 includes a moving unit 181 and the handle unit 182. The moving unit 181 and the handle unit 182 may be made of a non-metal material that is not conductive, and are used to control the up and down movement of the first electrode unit 132 through the first surface 111.

In detail, the moving unit 181 extends from the first electrode unit 132 in the third direction in a state in which it is fitted into the first guide groove 151. The moving unit 181 may be shaped as a rod. The moving unit 181 may be formed to have a width equal to or smaller than that of the first guide groove 151 so as to move within the first guide groove 151. For example, as illustrated in FIG. 5, a first end of the moving unit 181 may be connected to the first electrode unit 132 and a second end of the moving unit 181 may extend out of the first guide groove 151, so the moving unit may be moved with the first guide groove 151 to control movement of the first electrode unit 132.

The handle unit 182 is formed at an end of the moving unit 181 to be thicker than the moving unit 181 and locked on the locking unit 151b to then be fixed. The handle unit 182 may be formed to have a width greater than that of the locking unit 151b so as to be fixed to the locking unit 151b of the first guide groove 151, e.g., prevent undesired movement of the first electrode unit 132 once in a predetermined position.

The second guide groove 152 is shaped to fit the third guide groove 153 formed on each of the trays 100 stacked in the third direction to be adjacent to the third surface 113. That is to say, the second guide groove 152 provides a space in which the guide bar 180 of each of the trays 100 stacked in the third direction to be adjacent to the third surface 113 is fixed. In addition, the second guide groove 152 is formed on the first side surface to be symmetrical to the first guide groove 151 in view of a central region of the third surface 113. For example, when the first guide groove 151 is formed in a “C” shape, the second guide groove 152 may be formed in an inverted “C” shape.

Referring to FIG. 4D, the fourth surface 114 corresponds to a left side surface of the tray 100 and includes second fixing grooves 163 and 164, a third guide groove 153, and a fourth guide groove 154 formed thereon.

The second fixing grooves 163 and 164 are sized and shaped to fit the second fixing units 161 and 162 formed on the third surface 113 of the tray 100. That is to say, the second fixing grooves 163 and 164 are sized and shaped to fit the second fixing units 161 and 162 so as to be engaged therewith on each of the trays 100 stacked in a fourth direction perpendicular to the first or second direction and the left side of the trays 100 to be adjacent to the fourth surface 114.

The third guide groove 153 is formed in a region of the fourth surface 114, which is adjacent to the second electrode unit 122 formed on the first surface 111. The third guide groove 153 is formed such that a guide bar 185 extending from the second electrode unit 122 in the fourth direction is fitted into the third guide groove 153. The third guide groove 153 guides movement of the second electrode unit 122 by the guide bar 185 moving along the corresponding groove. The configuration and shape of the third guide groove 153 are substantially the same as those of the first guide groove 151, and detailed descriptions thereof will be omitted.

The fourth guide groove 154 is shaped to fit the first guide groove 151 formed on each of the trays 100 stacked in the fourth direction to be adjacent to the fourth surface 114. That is to say, the fourth guide groove 154 provides a space in which the guide bar 185 of each of the trays 100 stacked in the fourth direction to be adjacent to the fourth surface 114 is fixed. The configuration and shape of the fourth guide groove 154 are substantially the same as those of the second guide groove 152, and detailed descriptions thereof will be omitted.

In the aforementioned energy storage apparatus, trays are made into blocks to simplify the outer appearance of the energy storage apparatus, thereby simplifying the operational process of the energy storage apparatus without requiring a cable harness. Further, the energy storage apparatus can reduce the manufacturing cost by removing an unnecessary cable harness and simplifying the operational process of the apparatus.

By way of summary and review, cable harnesses connecting a plurality of trays may cause the conventional energy storage apparatus to have a complex configuration and may increase the manufacturing cost. However, as the exemplary embodiments provide an energy storage apparatus with block-shaped trays that fit into each other without a cable harnesses, the appearance and operational process of the apparatus is reduced and the manufacturing cost is decreased by removing unnecessary cable harnesses.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An energy storage apparatus, comprising:
a plurality of battery cells, each battery cell including a current collecting terminal; and
at least one tray receiving the plurality of battery cells, the tray including a coupling portion protruding in a first direction from a first surface of the tray, the coupling portion including an electrode unit having a first end electrically connected to the current collecting terminal and a second end movable in the first direction.

2. The energy storage apparatus as claimed in claim 1, wherein current collecting terminals of neighboring battery cells among the plurality of battery cells are electrically connected to each other through a bus bar, at least one of the current collecting terminals of the plurality of battery cells being electrically connected to the first end of the electrode unit.

3. The energy storage apparatus as claimed in claim 2, wherein the electrode unit includes a body part passing through the first surface of the tray, and a connecting portion extending from the body part in a second direction opposite to the first direction.

4. The energy storage apparatus as claimed in claim 3, wherein the connecting portion includes a receiving groove shaped to fit the current collecting terminal.

5. The energy storage apparatus as claimed in claim 4, wherein a sidewall of the tray with the first surface includes a through-hole, the body part passing through the through-hole.

6. The energy storage apparatus as claimed in claim 4, wherein the coupling portion includes a support unit on the first surface, the support unit surrounding exterior parts of the body part.

7. The energy storage apparatus as claimed in claim 4, wherein, when the electrode unit moves in the first direction, a bottom surface of the receiving groove and a top surface of the current collecting terminal are spaced apart from each other, and when the electrode unit moves in the second direction, the bottom surface of the receiving groove and the top surface of the current collecting terminal contact each other.

8. The energy storage apparatus as claimed in claim 4, wherein an inner wall of the receiving groove and an outer wall of the current collecting terminal contact each other.

9. The energy storage apparatus as claimed in claim 4, wherein the electrode unit further comprises an elastic body in the receiving groove, the elastic body having a first end coupled to a bottom surface of the receiving groove and a second end coupled to a top surface of the current collecting terminal.

10. The energy storage apparatus as claimed in claim 3, wherein the electrode unit further comprises an elastic body having a first end coupled to a bottom surface of the connecting portion and a second end coupled to a top surface of the current collecting terminal.

11. The energy storage apparatus as claimed in claim 1, wherein the coupling portion further comprises a connector unit on the first surface, the connector unit being integral with a battery management system (BMS) board and being electrically connected to the plurality of battery cells.

12. The energy storage apparatus as claimed in claim 11, wherein the coupling portion further comprises a first fixing unit spaced apart from the connector unit and protruding in the first direction.

13. The energy storage apparatus as claimed in claim 1, wherein the tray further comprises a coupling groove on a second surface opposite to the first surface, the coupling groove being shaped to fit the coupling portion.

14. The energy storage apparatus as claimed in claim 13, wherein the coupling groove includes a stepped portion shaped to fit the electrode unit.

15. The energy storage apparatus as claimed in claim 13, wherein:
the tray further comprises a plurality of side surfaces between the first surface and the second surface to connect the first surface to the second surface,
at least one second fixing unit and a first guide groove being positioned on a first side surface adjacent to the electrode unit among the side surfaces, the at least one second fixing unit being exterior to the tray and protruding in a third direction perpendicular to the first direction, and the first guide groove guiding movement of the electrode unit.

16. The energy storage apparatus as claimed in claim 15, wherein the first guide groove includes:
a guide unit along a direction in which the electrode unit moves; and
a locking unit extending from two ends of the guide unit in a direction perpendicular to the direction in which the electrode unit moves.

17. The energy storage apparatus as claimed in claim 16, wherein the electrode unit further comprises a guide bar extending in the third direction, the guide bar fitting into the first guide, groove.

18. The energy storage apparatus as claimed in claim 17, wherein the guide bar includes:
a moving unit extending from the electrode unit in the third direction and movable within the first guide groove; and
a handle unit at an end of the moving unit, the handle unit being thicker than the moving unit and being configured to lock in the locking unit.

19. The energy storage apparatus as claimed in claim 17, further comprising a second guide groove on the first side surface, the second guide groove being symmetrical to the first guide groove in view of a central region of the first side surface.

20. The energy storage apparatus as claimed in claim 17, wherein the electrode unit is rotatable inside a support unit by the guide bar, the support unit being on the first surface and surrounding exterior parts of the electrode unit.

21. The energy storage apparatus as claimed in claim 17, wherein the tray includes at least a first tray and a second tray, the first tray with a the first guide groove being stacked in the third direction on the second tray with a guide groove shaped to fit the first guide groove of the first tray.

22. The energy storage apparatus as claimed in claim 1, wherein the tray includes at least a first tray and a second tray, the first tray with a coupling portion being stacked in the first direction on the second tray with a coupling groove shaped to fit the coupling portion of the first tray.
